(19) United States
(12) Patent Application Publication
(10) Pub. No.: US 2008/0104800 A1
(43) Pub. Date: May 8, 2008

(54) Hinge structure

(75) Inventors: Jung-Wen Chang, Tao Yuan Shien (TW); Wen-Ji Tsai, Hsinchuang City (TW); Wan-Chi Lin, Taichung City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/712,981

(22) Filed: Mar. 2, 2007

(30) Foreign Application Priority Data
Nov. 7, 2006 (TW) 95219653

(51) Int. Cl. E05D 7/00

(52) U.S. Cl. 16/250

(57) ABSTRACT

A hinge structure is described. A hollow cylinder has a positioning slot in an inner wall thereof. A movable part has a positioning convex portion and a plurality of engraved portions. The positioning convex portion engages with the positioning slot such that the movable part slides within the hollow cylinder. A cover is fixed to the hollow cylinder to secure the movable part and the resilient part within the hollow cylinder. A resilient part is disposed between the cover and the movable part so as to provide the movable part a resilient recovery force. The engraved portions of the movable part are for engaging a rotatable member.

### RELATED APPLICATIONS

The present application is based on, and claims priority from, Taiwan Application Serial Number 95219653, filed on Nov. 7, 2006, the disclosure of which is hereby incorporated by reference herein in its entirety.

### BACKGROUND

1. Field of Invention

The present invention relates to a hinge structure.

2. Description of Related Art

An electronic device is equipped with a hinge to interconnect one part and the other part thereof such that one part can be rotated relative to the other part thereof. Nowadays, the hinge structure needs more functions, i.e. rotation positioning and rotation range restriction, besides its rotatable connection function for user's convenience. Therefore, an improved hinge structure is necessary.

### SUMMARY

A hinge module includes a hollow cylinder, a movable part and a cover. The hollow cylinder has a positioning slot in an inner wall thereof. The movable part has a positioning convex portion and a plurality of engraved portions, wherein the positioning convex portion engages with the positioning slot such that the movable part slides within the hollow cylinder. The engraved portions are radially arranged on the movable part. A resilient part is disposed within the hollow cylinder. The cover is fixed to the hollow cylinder to secure the movable part and the resilient part within the hollow cylinder. The resilient part is disposed between the cover and the movable part so as to provide the movable part a resilient recovery force. The engraved portions of the movable part are for engaging a rotatable member.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates an expansion device according to one embodiment of this invention;

FIG. 2 illustrates an exploded view of an expansion device according to one embodiment of this invention;

FIG. 3 illustrates an exploded view of a hinge body of the expansion device according to one embodiment of this invention; and

FIG. 4 illustrates two sides of a hollow cylinder according to one embodiment of this invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

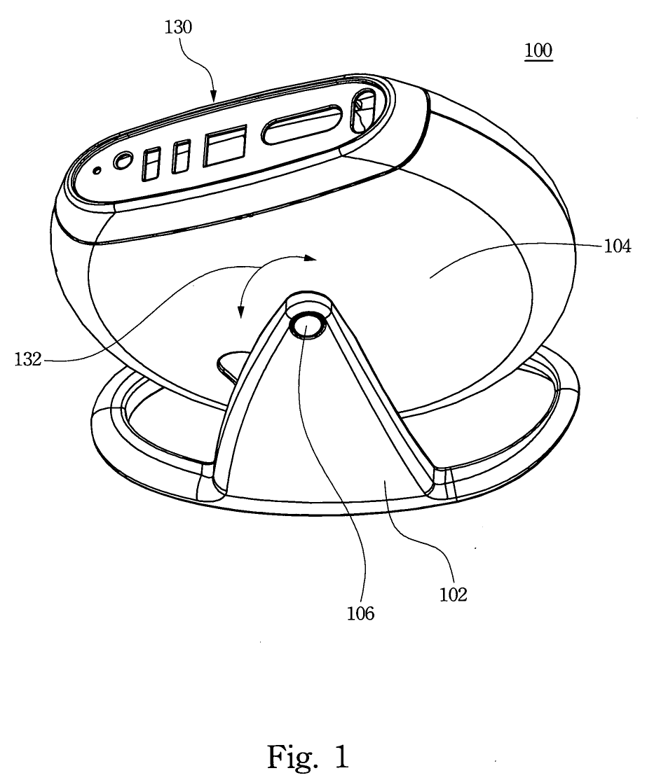

FIG. 1 illustrates an expansion device according to one embodiment of this invention. The expansion device 100 includes a stationary member 102 and a rotatable member 104. A hinge module 106 interconnects the stationary member 102 and the rotatable member 104. Thus, the rotatable member 104 can rotate relative to, along the rotation direction 132 for example, the stationary member 102 such that a connection interface 130 can be swiveled to a desired position where a connection connector is readily plugged and removed for users. The connection interface 130 includes several types of input/output ports, such as IEEE 1394, USB (Universal Serial Bus), D-sub, DVI or Audio ports to communicate computer accessories.

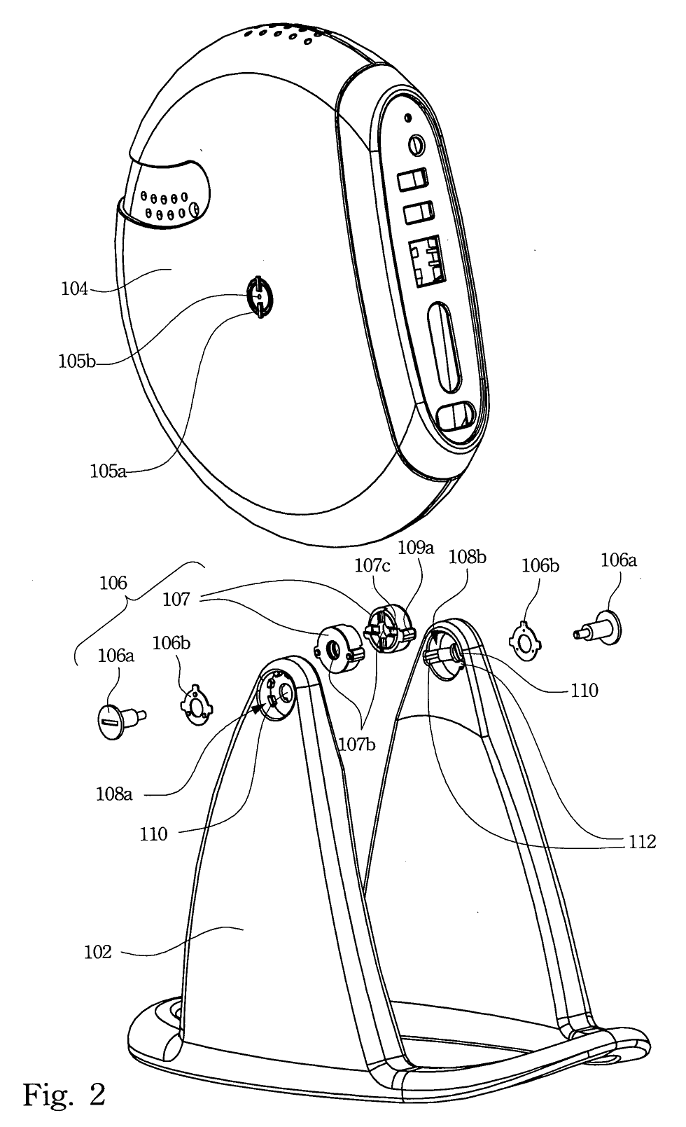

FIG. 2 illustrates an exploded view of an expansion device according to one embodiment of this invention. The hinge module 106 includes a screw 106a, a washer 106b and a hinge body 107. Two support frames of the stationary member 102 both include a circular concave section 108a and 108b. The circular concave section 108a is to accommodate the screw 106a and the washer 106b. The circular concave section 108b is to accommodate the hinge body 107. The circular concave section 108b has a fastening portion 112 and the hinge body 107 has a corresponding fastening portion 109a. When the concave fastening portion 112 engages with the convex fastening portion 109a, the hinge body 107 is secured with in the circular concave section 108b. The hinge body 107 has several engraved portions 107c to engage a bar 105a of the rotatable member 104. When the rotatable member 104 rotates, the bar 105a engages with one of the engraved portions 107c, thereby temporarily positioning the rotatable member 104.

How the expansion device being assembled is described below. The hinge body 107 is firstly accommodated within the circular concave section 108b. The rotatable member 104 is positioned between two support frames of the stationary member 102 with its bar 105a engaging with the engraved portions 107c of the hinge body 107. The washer 106b is then accommodated within the circular concave section 108a. The screw 106a is finally led through the washer 106b, the opening 110 of the circular concave sections 108b/108b and the hole 107b of the hinge body 107, and secured into the screw hole 105b of the rotatable member 104. The washer 106b can be an anti-wear metal member to prevent the screw 106a from scratching a surface of the stationary member 102.

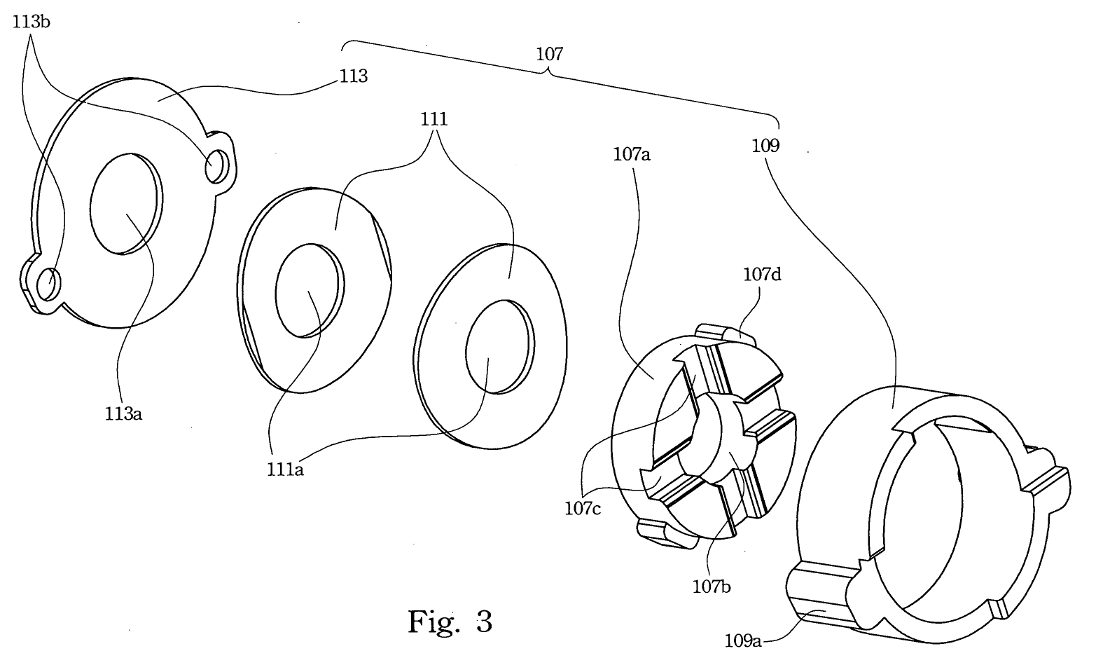

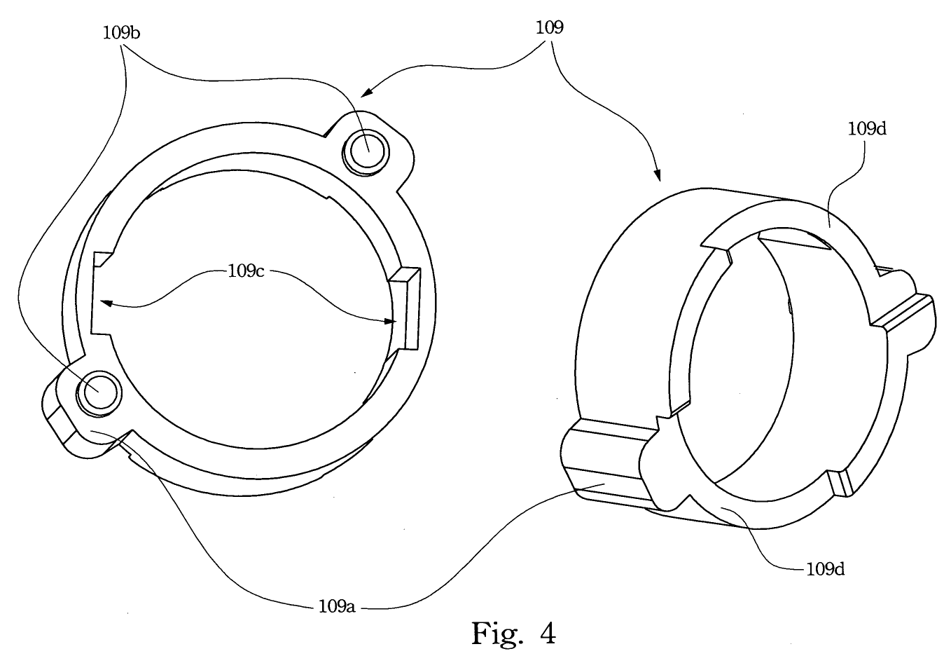

FIG. 3 illustrates an exploded view of a hinge body of the expansion device according to one embodiment of this invention. FIG. 4 illustrates two opposite sides of the hollow cylinder 109 in FIG. 3. The hinge body 107 provides the rotatable member 104 a temporary positioning function. The hinge body 107 includes a hollow cylinder 109, a movable part 107a, one (or more) resilient part 111 and a cover 113. The hollow cylinder 109 has positioning slots 109c (in inner walls) and cutouts 109d. The cutouts 109d of the hollow cylinder 109 is to restrict a rotation range of the bar 105a (of the rotatable member 104). Disk-shaped movable part 107a has positioning convex portions 107d, several engraved portions 107c and a hole 107b. The positioning convex portions 107d of the movable part 107a engages with the positioning slots 109c of the hollow cylinder 109 such that the movable part 107a slides within the hollow cylinder 109 along an axial direction (of the hollow cylinder 109). The engraved portions 107c are radially arranged on a side of the movable part 107a. The cover 113 has a hole 113a and mounting holes 113b.

When components of the hinge body 107 are assembled, the movable part 107a and the resilient part 111 are sequentially disposed inside the hollow cylinder 109 and then the cover 113 is fixed to the hollow cylinder 109. The 10 mounting holes 113b of the cover 113 engages with mounting pins 109b of the hollow cylinder 109, ends of the mounting holes 113a are pressed such that the cover 113 is fixed to the hollow cylinder 109 to secure the movable part 107a and the resilient part 111 within the hollow cylinder 109. The hole 107b of the movable part 107a, the hole 11 la of the resilient part 111 and the hole 113a of the cover 130 are all aligned such that the screw 106a can be led through for fastening. The resilient part 111 is disposed between the cover 113 and the movable part 107a to provide the movable part 107a a resilient recovery force along an axial direction (of the hollow cylinder 109) such that the bar 105a of the rotatable member 104 engages with one of the engraved portions 107c and a rotation positioning function is thus provided. The resilient part 111 can be a bent circular metal. One or more resilient parts 111 can be used to provide the movable part 107a a resilient recovery force.

Thus, the hinge module of the present invention can provide a target device a rotation positioning function and a restriction rotation range, and can be easily embedded inside a small volume space of the target device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hinge, comprising:
a hollow cylinder, having a positioning slot in an inner wall thereof;
a movable part, having a positioning convex portion and a plurality of engraved portions, wherein the positioning convex portion engages with the positioning slot such that the movable part slides within the hollow cylinder, the engraved portions are radially arranged on the movable part;
a resilient part, disposed within the hollow cylinder; and
a cover, fixed to the hollow cylinder to secure the movable part and the resilient part within the hollow cylinder, the resilient part being disposed between the cover and the movable part so as to provide the movable part a resilient recovery force, the engraved portions of the movable part are for engaging a rotatable member.

2. The hinge module of claim 1, wherein the movable part, the resilient part and the cover all have a hole, and all the holes are aligned.

3. The hinge module of claim 1, wherein the movable part is a disk-shaped movable part.

4. A device having a hinge module, comprising:
a stationary member;
a rotatable member, having a bar; and
a hinge module interconnecting the stationary member and the rotatable member such that the rotatable member rotates relative to the stationary member, wherein the hinge module comprising:
a hollow cylinder, having a positioning slot in an inner wall thereof;
a movable part, having a positioning convex portion and a plurality of engraved portions, wherein the positioning convex portion engages with the positioning slot such that the movable part slides within the hollow cylinder, the engraved portions are radially arranged on the movable part;
a resilient part, disposed within the hollow cylinder; and
a cover, fixed to the hollow cylinder to secure the movable part and the resilient part within the hollow cylinder, the resilient part being disposed between the cover and the movable part so as to provide the movable part a resilient recovery force, the bar of the rotatable member engaging with one of the engraved portions of the movable part.

5. The device of claim 4, wherein the movable part, the resilient part and the cover all have a hole, and all the holes are aligned.

6. The device of claim 5, wherein the rotatable member comprises a screw hole.

7. The device of claim 6, wherein the stationary member comprises an opening.

8. The device of claim 7, further comprising a screw to be led through the opening of the stationary member and the aligned holes of the hinge module, and secured into the screw hole of the rotatable member.

9. The device of claim 8, wherein the stationary member comprises a circular concave section for accommodating the hinge module, and the opening is disposed in the circular concave section.

10. The device of claim 8, further comprising a washer disposed between the screw and the stationary member.

11. The device of claim 10, wherein the stationary member comprises another circular concave section where the washer is disposed within.

12. The device of claim 5, wherein the rotatable member comprises a connection interface having a plurality of input and output ports.
